(19) United States
(12) Patent Application Publication
(10) Pub. No.: US 2011/0260878 A1
(43) Pub. Date: Oct. 27, 2011

(54) DEVICE FOR DETECTING THE LOAD AND/OR FILL STATUS OF A MEDICAL WASTE CONTAINER

(76) Inventor: Heinz Rigling, Althengstett (DE)

(21) Appl. No.: 13/127,918

(22) PCT Filed: Nov. 3, 2009
(86) PCT No.: PCT/EP09/07857

§ 371 Date: Jul. 8, 2011

(30) Foreign Application Priority Data
Nov. 5, 2008 (DE) 10 2008 055 974.1

(51) Int. Cl. G08B 21/00

(52) U.S. Cl. 340/665

(57) ABSTRACT

The invention relates to a device for detecting a load and/or fill status of a medical waste container (10) with a supporting unit (12) designed for the detachable mounting of the medical waste container (10), a pressure sensor unit (14) allocated to the supporting unit (12) and designed to interact with the waste container when the latter is placed on the supporting unit in such a way that as reaction to an application of pressure by the waste container caused by an attachment and/or filling process a pressure sensor signal is generated, an electronic evaluation unit (16) connected downstream of the pressure sensor unit and designed to evaluate the pressure sensor signal and to emit an activation signal to an alarm and/or signal unit (18) when a magnitude of the applied pressure and/or a level of the pressure sensor signal exceeds a predetermined threshold value.

### BACKGROUND OF THE INVENTION

The present invention relates to a device for detecting a mechanical load and/or fill status of a medical waste container.

From the prior art numerous types and variants of medical waste container are known which are used for a variety of types of waste occurring in everyday hospital and medical practice conditions and create the preconditions for safe disposal.

Thus, the applicant has for many years been marketing medical waste containers under the names “Rigi-Box” or “Quick-Box”, which are designed in particular as cannula boxes and are used for the secure storing of used syringes, cannulas and similar medical waste material. More particularly, such boxes are produced as thermoformed or injection moulded components in several parts from a plastic material, are filled by medical auxiliary personnel in everyday hospital practice with used material for disposal (whereby such boxes often have stripping means in the input and/or cover area, in order, for example, to loosen an cannula from a syringe), whereupon after being completely filled a box can be closed by a (typically suitably attached) lid and taken for subsequent disposal.

Here particular importance is attached to the health and safety aspects of sensitive (potentially dangerous) medical waste such as cannulas or scalpels. For example, if due to improper handling a medical waste box wall of the plastic material is accidentally pierced by a (used) cannula, there is a considerable risk of injury, extending as far as drastic medical consequences in the case of contaminated blood or similar residual substances on a cannula.

For these reasons medical waste containers (also: disposal boxes) are subject to regulations and approval restrictions which are intended to guarantee the tolerance and resilience of the containers to usage conditions (and potential misuse) of the above-described type: thus, through specifications relating to the minimum wall thickness and/or piercing resistance of the material used as well as the use of a filling line it should largely be assured that in normal operation accident situations of the aforementioned type do not occur. Nevertheless, not least because of sharp-edged or pointed waste materials (such as cannula tips, there is always a risk of injury through piercing a waste container wall. Therefore, in everyday use it is important to monitor the fill status of a waste container in order to replace a full container with an empty one in good time if there is a risk during (often hectic) surgical, hospital or ambulance use of medical personnel (inadvertently due to stress) piercing the container wall through further filling of an already filled waste container (as a result of applying pressure).

A known solution of allowing the fill status of a medical waste container to be detected in a simple and reliable way is to provide, along the mantle surface (usually in strip form) an axially extending area which allows the current fill status in the container to be assessed by an observer from outside. However such a known procedure has two drawbacks: on the one hand the plastic and injection moulding costs are increased (additional measures may have to be taken to manufacture this viewing section separately), and on the other hand in precisely this area there is again a risk potential due to material weakening, as it is here in particular that cannulas or similar pointed or sharp-edged medical waste objects can pierce the outer wall in an undesirable manner.

### SUMMARY OF THE INVENTION

The aim of the present invention is therefore to create a device for detecting a load and/or fill status of a medical waste container with which at low apparatus and design cost reliable load and/or fill status detection can take place both reliably and, more particularly, without negative effects on the design, stability and resilience of the filling container, with the particular intention of indicating to a user a fill status at which the waste container has to be replaced with an empty one in order to effectively prevent damage to the waste container by cannulas, syringe sets or similar medical waste objects already contained within it.

This objective is achieved by way of the device, the method and the use as disclosed herein, whereby on the basis of the present invention protection is claimed both for the detection device independently of the waste container, and for the combination of these components in the system as well as method of using this system. Advantageous further developments of the invention are also described herein.

Advantageously in accordance with the invention, for the mechanical detection of its load and/or fill status a waste container can as part of the invention be mounted (placed or and/or inserted into) a correspondingly designed supporting unit which has a pressure sensor unit. This supporting unit is designed to record the pressure exerted on the sensor unit (typically located underneath the waste container with regard to the filling direction) by the attachment and/or filling process (e.g. placing a medical waste object in the waste container) and on exceeding a predetermined pressure threshold (typically evaluated electronically) to emit a fill status information and/or warning signal.

Thus, in a surprisingly simple and elegant manner a clear indication can also be given to medical users in normal exertion or stress situations, as on exceeding the predetermined threshold (e.g. assuming as an example a pressure of 30 N on the sensor unit) the user is told through an acoustic, optical and/or tactile signal not to put in any more material by applying pressure (which could lead to an accident as described above) and instead to replace the container with an empty one.

Here it is part of the invention to design the alarm and/or signal emission of the alarm and/or signal unit in an informative manner, e.g. through suitable predetermined (possibly also multilingual or linguistically preconfigured) speech output, such as in the form of specific spoken information: “The pressure on the syringe is too high” or “Please replace the waste container now”. In addition, or alternatively, the information can be of an alarm type, such as clearly acoustically perceived alarms sounds, alternatively, or supported by, visual signals in the form of a flash or tactile signals such as vibrations.

It is also within the framework of the invention to expand the functionality of the evaluation unit so that in the signal processing it disregards a pressure load as occurs (as a continuous pressure signal) due to pressure loading of the sensor unit due to the mass of the filling material, while a pressure signal brought about as a reaction to the filling (or pushing or pressing in) of a further waste object into an already filled container triggers the activation signal in accordance with the invention. More particularly, in accordance with a further development, this is technically achieved through recording the dynamics and/or behaviour of the increase in the pressure signal which over time exhibits a steeper signal increase than a comparatively constant mass signal.

In the practical implementation, which is structurally simple and reliable in everyday use, it is also preferable to integrate the essential functional components of the invention into the supporting unit, whereby in accordance with a further development the supporting unit can also be connected to the waste container in such a way that on the one hand the supporting unit can serve as a fastening medium (e.g. onto a wall or in a rescue vehicle) and on the other hand the fastening between the supporting unit and the waste container easily allows pressure transmission to the pressure sensor unit on or in the supporting unit. More particularly, a supporting unit envisaged via a detachable connection (e.g. a bayonet connection) below the waste container also allows not only the accommodation therein of the evaluation electronics for the sensor unit, which preferably are provided as a plurality of sensors on the edge beneath a housing edge of the waste container, but also the alarm and/or signal unit with a corresponding optical or acoustic signal emitter along with the (typically wireless and portable) energy source in the form of batteries, rechargeable batteries or suchlike.

Also in accordance with a further development it is envisaged within the framework of the invention not only to evaluate the pressure sensor signal for the primary alarm and filling information purposes, but also to provide various handling or status information which can be obtained from the pressure sensor signal. In accordance with a further development it is therefore preferred to configure the alarm and/or signal unit to the additional emission of a closure acknowledgement signal when after completion of the filling procedure (with still mounted waste container) the user operates in the envisaged manner and with the required operating pressure a closure section in the housing lid for secure sealing of the housing. Additionally or alternatively this further development concept envisages acknowledgement of the signal pattern (detectable by the pressure sensor unit) of successful placing of the waste container on the supporting unit by means of a corresponding information/acknowledgment signal (also perhaps suitable spoken information); thus, for example, the successful insertion, in accordance with a further development, of the waste container in a bayonet unit provided by the supporting unit can be confirmed acoustically, optically or through vibration in the manner described above.

In the advantageous further development in accordance with the invention it is also envisaged to provide an activation of the detection unit in accordance with the invention, more particularly the evaluation unit and the alarm and/or signal unit in such a way that before correct detection operation within the context of the invention a user must either manually carry out this activation, for instance by operating a switch, entering a suitable combination of numbers and/or letters into a corresponding operating unit or suchlike, with the intention that only waste containers which have been properly checked for safety and are usable for the intended purpose (only these are then provided with a corresponding activation code or contain this code in an outer packaging etc.) can be properly used on the installation. Such activation can also take place automatically, for example through the activation means provided in accordance with the further development reading a suitable (RFID) chip or similar code from a properly checked waste container (e.g. after successful placement on the supporting unit) and only then activating the system, thereby ensuring that only properly suitable waste containers can be used in the manner according to the invention. The speech emission unit envisaged in accordance with a further development also provides the possibility of issuing a corresponding information or warning signal in the event of an impermissible waste container or one which is not suitable for activation.

As a result, in a surprisingly simple and elegant manner, and ensuring maximum operating safety, the present invention allows the sensitive, accident-prone disposal process of potentially problematic waste materials to be mastered, whereby, in particular, the preconditions are created for effectively preventing the disadvantageous, hazardous overfilling of a medical waste container and/or harmful pressure exertion thereon, and whereby users can be given (optical, acoustic or tactile) information which is potentially critical for making a decision. In this way it can be expected that through the effect of the invention the operational security of known medical waste containers will be drastically increased without the container itself having to be structurally modified; rather, in accordance with the invention and on the basis of the system, the problem-free interaction of the detection device in accordance with the invention with a plurality of interchangeable waste containers is guaranteed over long operating periods (whereby, again in accordance with a further development, the alarm and/or signal unit can also indicate decreasing battery power or similar operating conditions requiring manual intervention or maintenance measures).

### BRIEF DESCRIPTION OF THE DRAWINGS

Further advantages, features and details of the invention are set out in the further description of preferred examples of embodiment as well as by way of the drawings.

FIG. 1 shows a perspective view of the device for detecting a fill status of a medical waste container in accordance with a first example of embodiment of the present invention;

FIG. 2 shows an exploded view of the device in accordance with FIG. 1 with the mounting ring removed compared with the mounted position in FIG. 1;

FIG. 3 shows a use of the device in accordance with the example of embodiment in FIGS. 1, 2 together with a conventional waste container, whereby this is in the mounted position, and

FIG. 4 shows a schematic block diagram to illustrate essential functional components and their interaction during the implementation of the example of embodiment in accordance with FIG. 1, FIG. 2.

### DETAILED DESCRIPTION

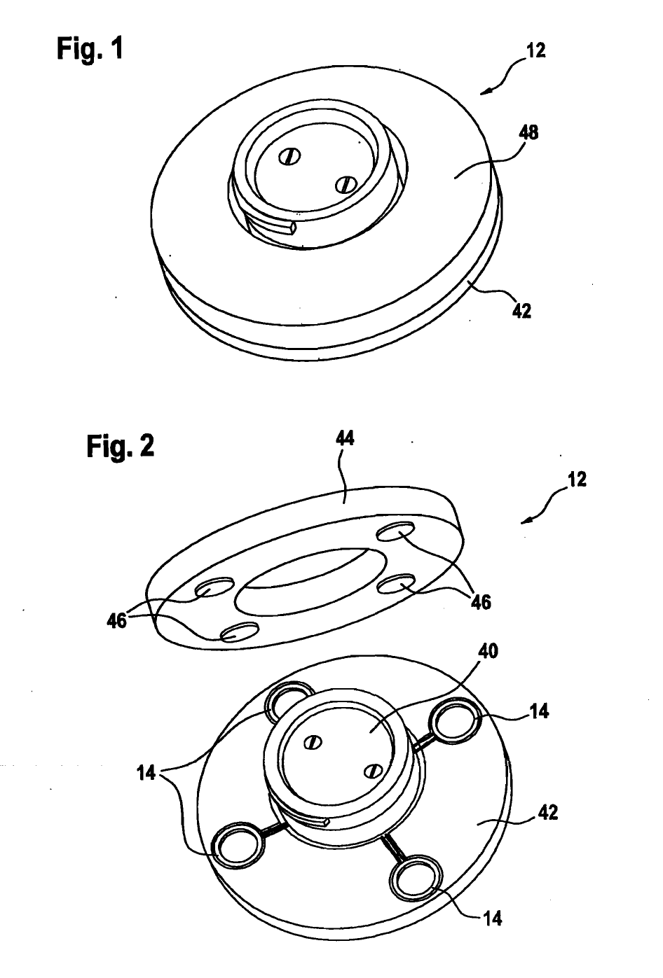

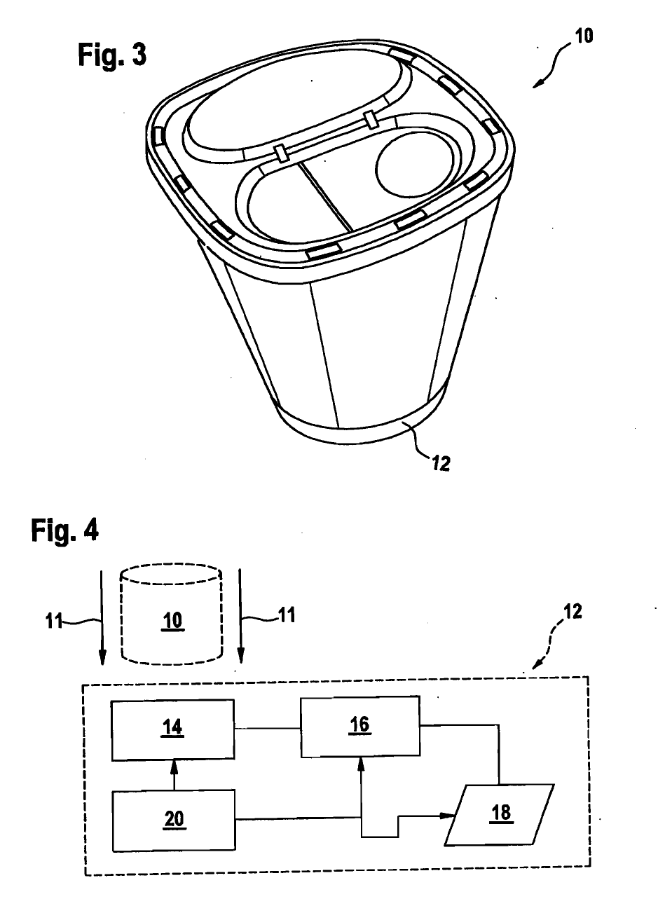

The example of embodiment in FIG. 1, 2 has a flat cylindrical supporting unit 12 which in its upper middle area has a bayonet projection 40 for connecting to the base area of a waste container 10 (FIG. 3) to be mounted on it. The waste container, which in a manner not shown in more detail, has on its base a holding fixture for interacting with the bayonet projection 40 and can in this way be detachably connected to the unit 12.

As illustrated in particular by the exploded drawing in FIG. 2, the supporting unit 12 comprises a disc-shaped pedestal element 42 on its base into which, distributed along the edge, a plurality of four pressure sensors 14, is set; the pressure input side of the pressure sensors 14 points upwards, parallel to the flat side. On the pedestal element 42 which has a central connector/recess a mounting ring 44 is placed in an axially movable manner, which on the base side, i.e. in the direction of the pedestal element 42 or plurality of pressures sensors 14 bears a flushly arranged projecting plurality of pressure transmitters 46.

In this way, in the assembled condition in accordance with FIG. 3, a pressure exerted on a upper flat side 48 of the mounting ring 44 (e.g. through the casing floor or a lower wall section of the waste container 10, cf. FIG. 3) can be transmitted via the projecting elements 46 to the pressure sensors 14, which are then interconnected to generate the pressure sensor signal in accordance with the invention and are evaluated. In a manner not shown in more detail in FIGS. 1 to 3, in internal hollow spaces the pedestal element contains evaluation electronics which are electronically connected to the pressure sensors 14, evaluate their pressure sensor signal and generate an activation signal for an alarm or signal unit (see FIG. 4, reference number 18), whereby all these units, including a power supply unit 20, are provided in the supporting unit 12 in the shown example of embodiment.

Specifically the block diagram in FIG. 4 shows the interaction of the units in accordance with the invention: in the event of impermissible filling, e.g. the exertion of a pressing in or filling pressure by a user into the already filled box by trying to put in a further waste object, the waste container 10, shown by the dashed line, exerts a correspondingly high pressure along arrow 11 on the pressure sensor unit 14 (the plurality of pressure sensors as shown in FIG. 2); the dashed line 12 shows the boundary between the waste container 10 and the supporting unit in accordance with the invention. The pressure sensor unit 14 is electrically connected to an evaluation unit 16, typically in the form of a suitable programmed and wired microcontroller unit, which, like the pressure sensor unit 14 is supplied by a wireless power supply unit 20 with an operating voltage (in accordance with further development this power supply unit 20 can have batteries or rechargeable batteries, and can also be in the form of mobile power generators, e.g. solar cells).

Having been evaluated in the manner described above, the pressure signals and pressure signal courses of the pressure sensor unit 14 then in the manner in accordance with the invention trigger an activation signal to an alarm and/or signal unit 18, more particularly, and in this case in accordance with a further development, if through appropriate analysis of the pressure signal pattern and course over time the evaluation unit 16 determines that the pressure signal detected by the unit 14 is not due purely to fill status or weight-related, but is the result of potential accident-causing filling pressure on the container 10. A typical pressure threshold is in the range from approx. 15 to 30 N.

As a reaction to the activation signal the alarm and/or signal unit 18 emits a suitable predetermined acoustic, optic and/or tactile signal, whereby within the framework of the invention it is preferable to generate sound and/or speech signals, which, more preferably, are preconfigured or can be configured to various country-specific specifications (linguistic or otherwise), a particular user situation or to achieve a desired signalling purpose (e.g. the generation of a clearly acoustically perceptible alarm tone which preferably becomes louder and louder). Accordingly it is preferred if an actual signal emitter, e.g. a loudspeaker, vibrating device or suchlike is provided in the supporting unit.

The present invention is not restricted to the described example of embodiment, but the evaluation and configuration possibilities provided in particular by the evaluation unit in accordance with the invention (reference number 16 in FIG. 4) can be used for other administration, information and monitoring purposes. A particularly advantageous further development of the invention consists in not restricting the evaluation of the pressure sensor signal of unit 14 to the above-described alarm threshold to prevent further potentially accident-provoking filling, but also to monitor and if necessary acknowledge or correct further operating statuses and situations that can be recorded through pressure sensing. Through pressure sensing it is already possible to monitor correct mounting of the container 10 on the supporting unit 12 through a corresponding typical signal course and to acknowledge completed mounting through a suitable signal (e.g. spoken message). Accordingly it is conceivable and advantageous after completion of filling to acknowledge successful closure of the waste container 10 (e.g. through pressing in a closure lid), as well as successful removal of the container, with an appropriately assigned signal. Last but not least effective power supply status or battery monitoring can be provided by the functionality of the evaluation unit and to this extent complete operational safety can be guaranteed.

While the present invention is particularly suitable for effectively monitoring and following the initially described sensitive situation of medical waste disposal, the present invention is not restricted to this purpose of use; rather, the device in accordance with the invention is in principle suitable for monitoring other container filling processes (including waste containers) in accordance with the critical pressure patterns produced thereby.

1. Device for detecting a load and/or fill status of a medical waste container (10), comprising
a supporting unit (12) designed for the detachable mounting of the medical waste container (10),
a pressure sensor unit (14) allocated to the supporting unit (12) and designed to interact with the waste container when the latter is placed on the supporting unit in such a way that as reaction to an application of pressure by the waste container caused by an attachment and/or filling process a pressure sensor signal is generated, and
an electronic evaluation unit (16) connected downstream of the pressure sensor unit and designed to evaluate the pressure sensor signal and to emit an activation signal to an alarm and/or signal unit (18) when a magnitude of the applied pressure and/or a level of the pressure sensor signal exceeds a predetermined threshold value.

2. Device in accordance with claim 1, further comprising means to record the course over time of the pressure sensor signal which are designed in such a way that the activation signal is only emitted if a dynamic and/or increase over time of the pressure sensor signal exceeds a predetermined reference value.

3. Device in accordance with claim 1, wherein the evaluation unit has means for the signal analysis of the pressure sensor signal which distinguish a signal level of the pressure sensor signal brought about by the filling mass of filled objects in the waste container and its change with the increase the filled material, from a signal level and signal level course brought about by the attachment and/or filling process.

4. Device in accordance with claim 1, wherein the supporting unit (12) has a plurality of pressure sensors (14) which are interconnected to produce the pressure sensor signal and/or are jointly evaluated.

5. Device in accordance with claim 4, wherein the plurality of pressure sensors is provided distributed circumferentially and/or on the edge, or in an area of the supporting unit to which the waste container is attached.

6. Device in accordance with claim 1, wherein the evaluation unit and/or the signal unit is/are integrated into the supporting unit.

7. Device in accordance with claim 1, wherein the signal unit has acoustic signal emitting means, more particularly means for emitting a predetermined speech signal.

8. Device in accordance with claim 1, wherein the signal unit has optical signal emitting means.

9. Device in accordance with claim 1, wherein the signal unit has motor-mechanical signal emitting means.

10. Device in accordance with claim 1, wherein the supporting unit has wireless power supply means.

11. Device in accordance with claim 1, wherein the signal unit is designed for the additional generation of a power supply status signal, more particularly dependent on a predetermined power supply threshold.

12. Device in accordance with claim 1, wherein the evaluation device (16) is designed for the additional emitting of a closure acknowledgment signal to the signal until (18) in response to a course of signals of the pressure sensor signal corresponding to a closure procedure carried out on the waste container.

13. Device in accordance with claim 1, wherein the evaluation unit (16) is designed for the additional emitting of a mounting acknowledgement signal (18) to the signal unit in response to a course of the pressure sensor signal corresponding to mounting of the waste container.

14. Device in accordance with claim 1, wherein the evaluation unit or the alarm and/or signal unit have activation means which in response to a manual activation and/or activation brought about by a mounted waste container, activate the evaluation of the pressure sensor signal.

15. Device in accordance with claim 14, wherein the activation means are designed for recording for activation an activation code provided on or in a mounted waste container.

16. Method of detecting a load and/or fill status of a medical waste container, comprising the steps of:
placing filling material into the waste container,
recording a pressure exerted by the waste container on a pressure sensor located beneath it,
comparing an electronic sensor signal corresponding to the exerted pressure with a threshold value and/or reference signal, and
emission of an information, warning and/or alarm signal if the sensor signal exceeds the threshold value or deviates from the reference signal.

17. Method in accordance with claim 16 further comprising:
recording of a time course of the sensor signal and
distinguishing a static level of the sensor signal determined by a mass of the filled material, from a dynamic sensor signal level brought about by filling with filling material.

18. Method in accordance with claim 16, wherein the emission of the information, warning and/or alarm signal comprises the electronic generation and emission of a signal which is selected from the group consisting of acoustic sound signals, acoustic speech signals, optic signals, vibration signals and combinations thereof.

19. Method in accordance with claim 16, further comprising:
recording of a closure sensor signal corresponding to a closure operation of the waste container and
emission of an acknowledgment signal deviating from the information, warning and/or alarm signal as a response to the closure sensor signal.

20. Method in accordance with claim 16, further comprising:
mounting the waste container on a supporting unit which has a pressure sensor unit and detachably locking the waste container on or in the supporting unit so that a pressure and/or force applied on the waste container allows the recording of the pressure exerted by the waste container on the pressures sensor unit as a reaction to filling with filling material.

21. Use of the device in accordance with claim 1, to prevent damage to the waste container through filling material located in the waste container.

22. Use of the device in accordance with claim 1, with a plurality of waste containers which are interchangeable on the supporting unit as a container monitoring system.

23. Device for detecting a load and/or fill status of a medical waste container, comprising
a supporting unit designed for the detachable mounting of the medical waste container,
a sensor unit which is allocated to the supporting unit and by means of optical, acoustic, inductive and/or electromagnetic measuring methods, generates a sensor signal corresponding to the load and/or fill status of the waste container,
an evaluation device connected downstream of the sensor unit designed for evaluating the pressure sensor signal and emitting an activation signal to an alarm and/or signal unit if a level of the sensor signal exceeds a threshold value corresponding to a predetermined fill status.

24. Device in accordance with claim 9, wherein the motor-mechanical signal emitting means comprises a vibration generator.

25. Device in accordance with claim 10, wherein the wireless power supply means comprises a battery unit and/or solar cell.

26. Method in accordance with claim 16, wherein the emission step is carried out if the sensor signal exceeds a predetermined tolerance measurement.

27. Device in accordance with claim 23, wherein the means of optical, acoustic, inductive and/or electromagnetic measuring methods are in the interior of the medical waste container.
